(19) United States
(12) Patent Application Publication
(10) Pub. No.: US 2024/0392047 A1
(43) Pub. Date: Nov. 28, 2024

(54) CATALYST COMPONENT FOR PROPYLENE POLYMERIZATION WITH IMPROVED CATALYST PERFORMANCE

(71) Applicant: W.R. Grace & Co.-CONN, Columbia, MD (US)

(72) Inventors: Vladimir P. MARIN, Columbia, MD (US); Keith G. HILFERDING, Pearland, TX (US); Ahmed HINTOLAY, Columbia, MD (US)

(73) Assignee: W.R. Grace & Co.-CONN, Columbia, MD (US)

(21) Appl. No.: 18/689,040

(22) PCT Filed: Aug. 30, 2022
(86) PCT No.: PCT/US2022/042086

§ 371 Date: Mar. 4, 2024

Related U.S. Application Data
(60) Provisional application No. 63/240,300, filed on Sep. 2, 2021.

(51) Int. Cl. C08F 110/06

(52) U.S. Cl. CPC C08F 110/06; C08F 2410/01

(57) ABSTRACT

An isolated solid catalyst component for olefin polymerization. The catalyst component comprises a halide-containing magnesium compound, a titanium halide compound, a supportive donor comprising a benzoate, an internal electron donor, and an activity control agent (AC A). The AC A comprises at least one of: i) a first organosilicon compound containing Si—O groups being present in the catalyst component in an amount from about 0.1 to about 5% by weight: ii) an organic ester of a C₄ to C₃₀ aliphatic acid or a poly (alkene glycol) ester of a C₄ to C₃₀ aliphatic acid in amount from about 0.1% to about 15% by weight: and iii) an organo-aluminum compound containing an alkyl group. At least a part of the ACA is chemically bonded to the halide-containing magnesium compound.

### CROSS REFERENCE TO RELATED APPLICATIONS

This application claims the benefit of priority to U.S. Provisional Patent Application No. 63/240,300 filed Sep. 2, 2021, which is hereby incorporated by reference, in its entirety for any and all purposes.

### BACKGROUND

Polyolefins are a class of polymers derived from simple olefins. Known methods of making polyolefins involve the use of Ziegler-Natta polymerization catalysts. These catalysts polymerize olefin monomers using a transition metal halide to provide a polymer with various types of stereochemical configurations.

One type of Ziegler-Natta catalyst system comprises a solid catalyst component, constituted by a magnesium halide on which are supported a titanium compound and an internal electron donor compound. In order to maintain high selectivity for an isotactic polymer product, internal electron donor compounds are added during catalyst synthesis. The internal donor can be of various types. Conventionally, when a higher crystallinity of the polymer is required, an external donor compound is also added during the polymerization reaction.

During the past 30 years, numerous supported Ziegler-Natta catalysts have been developed which afford a much higher activity in olefin polymerization reactions and much higher content of crystalline isotactic fractions in the polymers they produce. With the development of internal and external electron donor compounds, polyolefin catalyst systems are-continuously renovated.

One problem encountered with newly developed Ziegler-Natta catalysts, particularly non-phthalate catalysts, is that the catalysts produce a significantly high catalyst activity immediately during the polymerization process. The high catalyst activity can lead to a rapid temperature increase in the center of the catalyst particles. In some applications, the surface area of the catalyst particles is not sufficient to allow heat to dissipate, causing the particles to break up or otherwise degrade.

Another problem with catalysts having high activity is that they usually exhibit a high level of decay in activity during the polymerization process. This decay makes it difficult to use such high activity catalysts in multi-reactor polymerization processes for producing certain polymer products, such as impact copolymers.

In order to control catalyst kinetics, some polymerization processes, namely slurry phase polymerization processes or bulk phase polymerization processes, are equipped with a prepolymerization line or reactor. In other polymerization processes, such as gas phase processes, the kinetics of the polymerization process can be slightly improved by external donors and activity limiting agents. However, there is a need for greater improvement in controlling polymerization kinetics.

### SUMMARY

The present disclosure is generally directed to an isolated solid catalyst component for olefin polymerization. The catalyst component comprises a halide-containing magnesium compound, a titanium halide compound, a supportive donor comprising a benzoate, an internal electron donor, and an activity control agent (ACA). The ACA comprises at least one of: i) a first organosilicon compound containing Si—O groups being present in the catalyst component in an amount from about 0.1 to about 5% by weight; ii) an organic ester of a C4 to C30 aliphatic acid or a poly (alkene glycol) ester of a C4 to C30 aliphatic acid in amount from about 0.1% to about 15% by weight; and iii) an organo-aluminum compound containing an alkyl group. At least a part of the ACA is chemically bonded to the halide-containing magnesium compound.

The present disclosure is also directed to a process for making the isolated solid catalyst component. The process comprises the following steps: a) forming a catalyst precursor component by reacting a magnesium alkoxide Mg(OR)ₙX₂₋ₙ or magnesium alcoholate MgX₂·mR′OH with Ti(OR″)_{g}X_{4-g} wherein X is Br, Cl, or I; n is 1, 2; m is 0.5-10; g is 0, 1, 2, 3, or 4; and R, R′, R″ are independently C1-C10 alkyl, the catalyst precursor containing a supportive electron donor and an internal electron donor; b) reacting the catalyst precursor component with at least one of: i) a first organosilicon compound having the following formula: R₂nSi(OR₃)₄₋ₙ, wherein R₂ is H, alkyl, or aryl; each R₃ is alkyl, or aryl; n is 0, 1, 2 or 3 in hydrocarbon solvent; ii) an organic ester from a C4 to C30 aliphatic acid ester or a poly (alkene glycol) ester of a C4 to C30 aliphatic acid; and iii) an alkyl aluminum compound; and c) isolating the solid catalyst component.

A process for producing an olefin polymer is also provided. The process comprises polymerizing an olefin in the presence of a solid catalyst component. The solid catalyst component comprises a reaction product of: a) a halide-containing magnesium compound; b) a titanium halide compound; c) at least one internal electron donor; and d) an activity control agent (ACA). The ACA comprises at least one of: i) a first organosilicon compound containing Si—O groups being present in the catalyst component in an amount from about 0.1 to about 5% by weight; ii) an organic ester of a C4 to C30 aliphatic acid or a poly (alkene glycol) ester of a C4 to C30 aliphatic acid in amount from about 0.1% to about 15% by weight; and iii) an organo-aluminum compound containing an alkyl group. At least a part of the ACA is chemically bonded to the halide-containing magnesium compound.

Other features and aspects of the present disclosure are discussed in greater detail below.

### BREIF DESCRIPTION OF THE DRAWINGS

The present disclosure may be better understood with reference to the following figure:

FIG. 1 is a chart comparing the FTIR spectra of a catalyst component containing an ACA made in accordance with the present disclosure to a catalyst component without an ACA.

### DETAILED DESCRIPTION

Before describing several exemplary embodiments, it is to be understood that the invention is not limited to the details of construction or process steps set forth in the following description. The invention is capable of other embodiments and of being practiced or being carried out in various ways.

In general, the present disclosure is directed to catalyst components for producing polyolefin polymers, particularly polypropylene, polyethylene, and copolymers thereof, and methods of making such catalyst components. The present disclosure is also directed to methods of polymerizing olefins using the catalyst components. In general, the catalyst component of the present disclosure is a reaction product of a halide-containing magnesium compound, a titanium halide compound, a mono benzoate supportive electron donor, at least one internal electron donor, and an activity control agent (ACA) comprising (a) an organosilicon compound containing Si—O groups, (b) an organic ester of a C4 to C30 aliphatic acid or a poly (alkene glycol) ester of a C4 to C30 aliphatic acid, (c) an organoaluminum compound containing an alkyl group, or any combination thereof.

The present inventors discovered that treating a catalyst precursor containing a mono benzoate supportive donor and an internal donor supported on a magnesium halide compound with an ACA prior to polymerization unexpectedly results in a high level of incorporation of the ACA into the catalyst component, partial removal of the supportive donor from the catalyst component, and a change in coordination of the internal donor on the magnesium halide support surface due to bonding between the ACA and the halide-containing magnesium compound.

Additionally, the inventors unexpectedly discovered that the resulting catalyst component exhibits an improved lifetime and relatively flat polymerization kinetics, which provide significant advantages when using the catalyst component in a multi-reactor polymerization system, such as a system for producing an impact copolymer. For example, the level of catalytic activity remains more constant over a relatively long period of time, such as longer than an hour, instead of being very high at the beginning of polymerization and then quickly tapering off. As some multi-reactor polymerization processes require the catalyst to remain active for multiple hours, the more stable kinetics of the catalyst component described herein are desirable.

The inventors further discovered that the catalyst lifetime can be controlled by changing the coordination of the internal donor on the magnesium halide surface using variable activation conditions and variable amounts of the internal donor.

One measure of catalyst lifetime is to compare the catalytic activity over the course of the first hour of polymerization with the catalytic activity over the course of the second hour of polymerization. High catalytic activity during the first hour of polymerization followed by much lower catalytic activity during the second hour is evidence that the catalyst has a short lifetime. When the level of activity during the second hour is similar to that of the first hour, the catalyst generally has a longer lifetime. In certain polymerization process, such as multi-reactor processes that take place over the course of multiple hours, it is more desirable to have a longer catalyst lifetime, even if the level of activity is slightly lower in the beginning. In this regard, the catalyst component described herein exhibits a relatively long lifetime as measured by comparing catalytic activity over the first hour of polymerization with the catalytic activity during the second hour of polymerization. For example, the change in catalytic activity from the first hour to the second hour is generally about 30% or less, such less than about 25%, such as less than about 20%, such as less than about 15%, such as less than about 10%, such as less than about 5%. In some embodiments, the catalytic activity is greater in the second hour than in the first hour.

Usually, a catalyst contains 3-5 major types of active centers, which differ in activity and other polymerization characteristics. Highly active catalyst centers usually have a short lifetime. Therefore, to improve polymerization kinetics, it is necessary to have multi-site active catalytic centers with narrow catalyst activity. Without intending to be limited by theory, it is believed that the improvement in catalyst lifetime is related to changing the internal donor coordination on the magnesium halide support by increasing the concentration of weakly coordinated complexes with the magnesium halide. It is believed that the weakly coordinated internal donor can be easily withdrawn by a cocatalyst, such as triethylaluminum (TEAI), at the initial stage of the polymerization process, resulting in the reduction of very active catalytic centers at the beginning of the polymerization process and, therefore, increasing the catalyst lifetime.

Additionally, in some polymerization processes using active catalysts, a polymerization temperature might be raised in certain spots of the reactor resulting in uncontrolled polymerization and plugging of the polymerization reactor. Catalysts containing an ACA can reduce the catalyst activity at high polymerization temperatures (i.e., they are self-extinguishing) and improve the polymerization process. For example, in some embodiments, the catalyst activity at 90° C. may be at least about 10% less, such as from about 12% to about 20% less, than the catalyst activity at 80° C. when determined over a 30-minute period.

The improved catalysts can also produce polymers with improved morphology, such as improved bulk density, particle shape, and sphericity, which leads to better commercial processability. For example, in highly productive commercial processes, the production of spherical polymer particles with a high bulk density and without breakage is desired.

In this regard, polymer powders made according to the present disclosure can have an average particle size of greater than about 5 microns, such as greater than about 50 microns, such as greater than about 100 microns, such as greater than about 300 microns, such as greater than about 500 microns. The average particle size of the polymer particles can generally be less than about 3,000 microns, such as less than about 2,000 microns, such as less than about 1,600 microns. As described above, the polymer particles can be substantially spherical. For instance, the polymer particles can have a B/L3 of greater than about 0.65, such as greater than about 0.7, such as greater than about 0.75, such as even greater than about 0.8 and generally less than 1. Additionally, the polymer particles can have a sphericity (SPHT) of greater than about 0.80, such as greater than about 0.85, such as greater than about 0.9, such as greater than about 0.95, and generally less than 1.

Due to the particle morphology, polymer resins made according to the present disclosure can also have increased bulk density and thus good flow properties. The bulk density of the polymer particles, for instance, can be greater than about 0.35 g/cc, such as greater than about 0.38 g/cc, such as greater than about 0.4 g/cc, such as greater than about 0.41 g/cc. The bulk density is generally less than about 0.55 g/cc, such as less than about 0.50 g/cc.

A high catalytic activity level can be achieved using the catalyst component of the present disclosure. For example, the average catalytic activity over the first two hours of polymerization can be greater than 40 kg/g/h, such as greater than 50 kg/g/h, such as greater than 60 kg/g/h, such as greater than 70 kg/g/h, such as greater than 80 kg/g/h, such as greater than even 90 kg/g/h.

Advantageously, the catalyst component is prepared outside of the polymerization reactor than can therefore be stored and used in dry form or in a hydrocarbon solvent or mineral oil.

In one embodiment, the method of preparing the catalyst component of the present disclosure includes the step of forming a catalyst precursor containing a magnesium compound, a titanium compound, a supportive donor, and an internal electron donor. The catalyst precursor is then reacted with (a) an organosilicon compound containing Si—O groups; (b) an organic ester from a C₄ to C₃₀ aliphatic acid ester or a poly (alkene glycol) ester of a C₄ to C₃₀ aliphatic acid; (c) an organo-aluminum compound containing an alkyl group; or any combination thereof. In another embodiment, the activity control agent is added during the incorporation of the internal donor.

### A. Catalyst Precursor

When a catalyst precursor is formed prior to incorporating the activity control agent, it generally includes a magnesium compound and a titanium compound combined with a supportive electron donor and at least one internal electron donor.

In one embodiment, the catalyst precursor is a mixed magnesium/titanium compound having the formula MgdTi(OR^{e})fX, wherein R^{e} is an aliphatic or aromatic hydrocarbon radical having 1 to 14 carbon atoms or COR′ wherein R′ is an aliphatic or aromatic hydrocarbon radical having 1 to 14 carbon atoms; each OR^{e} group is the same or different; X is independently chlorine, bromine or iodine; d is 0.5 to 56, or 2 to 4; f is 2 to 116 or 5 to 15; and g is 0.5 to 116, or 1 to 3. The catalyst precursor component can be prepared by controlled precipitation through removal of an alcohol from the reaction mixture used in its preparation. In one embodiment, a reaction medium comprises a mixture of an aromatic liquid, especially a chlorinated aromatic compound, such as chlorobenzene, with an alkanol, such as ethanol. Suitable halogenating agents include titanium tetrabromide, titanium alkoxide, titanium tetrachloride or titanium trichloride. Removal of the alkanol from the solution used in the halogenation, results in precipitation of the solid catalyst precursor component.

For example, in one embodiment, the catalyst precursor component comprises the reaction product of a magnesium alkoxide, such as magnesium ethylene oxide, with a mixture of o-cresol, titanium ethoxide, titanium tetrachloride, and ethanol in the presence of an internal electron donor. During the process, in one embodiment, a supportive electron donor is formed as a side product and incorporated into the catalyst. In addition, the supportive donor can be formed as a side product in situ by a reaction of the internal donor with the reaction mixture.

In another embodiment, the catalyst precursor component is formed from a magnesium alcoholate, a titanium halide, a supportive electron donor, and an internal electron donor. For example, in one embodiment, a solid magnesium alcoholate is treated with the titanium halide, removing alcohol. The internal and supportive donors can be added at different steps of the process to vary the solid catalyst component properties.

For example, the catalyst precursor can be an alcohol adduct of anhydrous magnesium halide. The anhydrous magnesium halide adduct is generally defined as MgX₂-nROH where n has a range of 0.5-10, preferably 2.5-4.0, and most preferably 2.8-3.5 moles total alcohol. ROH is a C₁-C₄ alcohol, linear or branched, or a mixture of alcohols. Preferably ROH is ethanol or a mixture of ethanol and a higher alcohol. If ROH is a mixture, the mole ratio of ethanol to higher alcohol is at least 80:20, preferably 90:10, and most preferably at least 95:5.

In one embodiment, a substantially spherical MgCl-nEtOH adduct may be formed by a spray crystallization process.

In another embodiment, the catalyst precursor is formed by dissolving a halide-containing magnesium compound in a mixture, where the mixture includes an epoxy compound, an organic phosphorus compound, and a hydrocarbon solvent, to form a homogenous solution. The homogenous solution can then be treated with a supportive donor in the presence of an organosilicon compound and a hydrocarbon solvent. A titanium halide compound can then be added to form a solid precipitate. The precipitate can then be combined with a hydrocarbon solvent to form a mixture. An internal electron donor in a hydrocarbon solvent can then be added to the mixture. The resulting solid can then be filtered and may be further treated with a titanium halide to form the catalyst precursor.

In a particular embodiment, the halide-containing magnesium compound, epoxy compound, and organic phosphorus compound are reacted in the presence of an organic solvent at a first temperature from about 25 to about 100° C. to form a homogenous solution. In another embodiment, the first temperature is from about 40 to about 90° C. or from about 50 to about 70° C. In a certain embodiment, the molar ratio of the magnesium compound to alkylepoxide is from about 0.1:2 to about 2:0.1 or about 1:0.25 to about 1:4 or about 1:0.9 to about 1:2.2. In a certain embodiment, the molar ratio of the magnesium compound to the Lewis base is from about 1:0.1 to about 1:4 or 0.5:1 to 2.0:1 or 1:0.7 to 1:1. Without wishing to be bound by any theory, it is believed that a halogen atom is transferred from the magnesium compound to the epoxy compound to open the epoxide ring and form an alkoxide magnesium species having a bond between the magnesium atom and the oxygen atom of the newly formed alkoxide group. During this process, the organic phosphorus compound coordinates to a Mg atom of the halide-containing magnesium compound and increases the solubility of the magnesium-containing species present.

The organosilicon compound may be added during or after the dissolution of the magnesium compound in the organic solvent, along with the epoxy compound. The organosilicon compound may be a silane, a siloxane, or a polysiloxane. The organosilicon compound, in some embodiments, may be represented as Formula (II):

RₙSi(OR′)₄₋ₙ (II).

In Formula (II) each R may be H, alkyl, or aryl; each R′ may be H, alkyl, aryl, or —SiRn′(OR′)3-n, where n is 0, 1, 2, or 3.

In some embodiments, the organosilicon is a monomeric or polymeric compound. The organosilicon compound may contain —Si—O—Si— groups inside of one molecule or between others. Other illustrative examples of an organosilicon compound include polydialkylsiloxane and/or tetraalkoxysilane. Such compounds may be used individually or as a combination thereof. The organosilicon compound may be used with combination of aluminum alkoxides and the first internal donor. In some embodiments, polydimethylsiloxane and/or tetraethoxysilane may be used.

The titanium halide compound used to form the catalyst precursor can be represented as Ti(OR)_{g}X_{4-g} where each R is independently a C₁-C₁₀ alkyl; X is Br, Cl, or I; and g is 0, 1. 2, 3, or 4, such as TiCl₄.

The hydrocarbon solvent used in the production of the catalyst precursor can include aromatic or non-aromatic solvents or combinations thereof. In certain embodiments, the aromatic hydrocarbon solvent is selected from toluene and a C₂-C₂₀ alkylbenzene. In certain embodiments, the nonaromatic hydrocarbon solvent is selected from hexane and heptane.

Illustrative of the epoxy compounds include, but are not limited to, glycidyl-containing compounds of the formula:

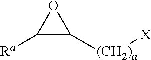

wherein “a” is from 1, 2, 3, 4, or 5, X is F, Cl, Br, I, or methyl, and R^{a} is H, alkyl, aryl, or cyclyl. In one embodiment, the alkylepoxide is epichlorohydrin. In some embodiments, the epoxy compound is a haloalkylepoxide or a nonhaloalkylepoxide.

According to some embodiments, the epoxy compound is selected from the group consisting of ethylene oxide; propylene oxide; 1,2-epoxybutane; 2,3-epoxybutane; 1,2-epoxyhexane; 1,2-epoxyoctane; 1,2-epoxydecane; 1,2-epoxydodecane; 1,2-epoxytetradecane; 1,2-epoxyhexadecane; 1,2-epoxyoctadecane; 7,8-epoxy-2-methyloctadecane; 2-vinyl oxirane; 2-methyl-2-vinyl oxirane; 1,2-epoxy-5-hexene; 1,2-epoxy-7-octene; 1-phenyl-2,3-epoxypropane; 1-(1-naphthyl)-2,3-epoxypropane; 1-cyclohexyl-3,4-epoxybutane; 1,3-butadiene dioxide; 1,2,7,8-diepoxyoctane; cyclopentene oxide; cyclooctene oxide; a-pinene oxide; 2,3-epoxynorbornane; limonene oxide; cyclodecane epoxide; 2,3,5,6-diepoxynorbornane; styrene oxide; 3-methylstyrene oxide; 1,2-epoxybutylbenzene; 1,2-epoxyoctylbenzene; stilbene oxide; 3-vinylstyrene oxide; 1-(1-methyl-1,2-epoxyethyl)-3-(1-methylvinyl benzene); 1,4-bis(1,2-epoxypropyl)benzene; 1,3-bis(1,2-epoxy-1-methylethyl)benzene; 1,4-bis(1,2-epoxy-1-methylethyl)benzene; epifluorohydrin; epichlorohydrin; epibromohydrin; hexafluoropropylene oxide; 1,2-epoxy-4-fluorobutane; 1-(2,3-epoxypropyl)-4-fluorobenzene; 1-(3,4-epoxybutyl)-2-fluorobenzene; 1-(2,3-epoxypropyl)-4-chlorobenzene; 1-(3,4-epoxybutyl)-3-chlorobenzene; 4-fluoro-1,2-cyclohexene oxide; 6-chloro-2,3-epoxybicyclo[2.2.1]heptane; 4-fluorostyrene oxide; 1-(1,2-epoxypropyl)-3-trifluorobenzene; 3-acetyl-1,2-epoxypropane; 4-benzoyl-1,2-epoxybutane; 4-(4-benzoyl)phenyl-1,2-epoxybutane; 4,4′-bis(3,4-epoxybutyl) benzophenone; 3,4-epoxy-1-cyclohexanone; 2,3-epoxy-5-oxobicyclo[2.2.1]heptane; 3-acetylstyrene oxide; 4-(1,2-epoxypropyl) benzophenone; glycidyl methyl ether; butyl glycidyl ether; 2-ethylhexyl glycidyl ether; allyl glycidyl ether; ethyl 3,4-epoxybutyl ether; glycidyl phenyl ether; glycidyl 4-tert-butylphenyl ether; glycidyl 4-chlorophenyl ether; glycidyl 4-methoxyphenyl ether; glycidyl 2-phenylphenyl ether; glycidyl 1-naphthyl ether; glycidyl 2-phenylphenyl ether; glycidyl 1-naphthyl ether; glycidyl 4-indolyl ether; glycidyl N-methyl-α-quinolon-4-yl ether; ethyleneglycol diglycidyl ether; 1,4-butanediol diglycidyl ether; 1,2-diglycidyloxybenzene; 2,2-bis(4-glycidyloxyphenyl) propane; tris (4-glycidyloxyphenyl) methane; poly(oxypropylene) triol triglycidyl ether; a glycidic ether of phenol novolac; 1,2-epoxy-4-methoxycyclohexane; 2,3-epoxy-5,6-dimethoxybicyclo[2.2.1]heptane; 4-methoxystyrene oxide; 1-(1,2-epoxybutyl)-2-phenoxybenzene; glycidyl formate; glycidyl acetate; 2,3-epoxybutyl acetate; glycidyl butyrate; glycidyl benzoate; diglycidyl terephthalate; poly(glycidyl acrylate); poly(glycidyl methacrylate); a copolymer of glycidyl acrylate with another monomer; a copolymer of glycidyl methacrylate with another monomer; 1,2-epoxy-4-methoxycarbonylcyclohexane; 2,3-epoxy-5-butoxycarbonylbicyclo[2.2.1]heptane; ethyl 4-(1,2-epoxyethyl) benzoate; methyl 3-(1,2-epoxybutyl) benzoate; methyl 3-(1,2-epoxybutyl)-5-pheylbenzoate; N,N-glycidyl-methylacetamide; N,N-ethylglycidylpropionamide; N,N-glycidylmethylbenzamide; N-(4,5-epoxypentyl)-N-methyl-benzamide; N,N-diglycylaniline; bis(4-diglycidylaminophenyl) methane; poly(N,N-glycidylmethylacrylamide); 1,2-epoxy-3-(diphenylcarbamoyl)cyclohexane; 2,3-epoxy-6-(dimethylcarbamoyl)bicycle [2.2.1]heptane; 2- (dimethylcarbamoyl)styrene oxide; 4-(1,2-epoxybutyl)-4′-(dimethylcarbamoyl)biphenyl; 4-cyano-1,2-epoxybutane; 1-(3-cyanophenyl)-2,3-epoxybutane; 2-cyanostyrene oxide; and 6-cyano-1-(1,2-epoxy-2-phenylethyl)naphthalene.

As an example of the organic phosphorus compound, phosphate acid esters such as trialkyl phosphate acid ester may be used. Such compounds may be represented by the formula:

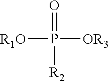

wherein R₁, R₂, and R₃ are each independently selected from the group consisting of methyl, ethyl, and linear or branched (C₃-C₁₀) alkyl groups. In one embodiment, the trialkyl phosphate acid ester is tributyl phosphate acid ester.

As described above, at least one internal electron donor is present during the synthesis of the catalyst precursor. An internal electron donor is a compound added or otherwise formed during formation of the catalyst precursor that donates at least one pair of electrons to one or more metals present in the resultant catalyst support. A supportive donor is also present. The supportive donor is a reagent added in the support synthesis and/or formed during the process of constructing the catalyst precursor that binds to the magnesium surface and remains in the catalyst precursor, similar to the internal electron donor. The supportive donor is usually smaller (less bulky) and produces a weaker coordination with the catalyst support than the internal electron donor.

The catalyst component may be converted to a solid catalyst by way of halogenation. Halogenation includes contacting the catalyst component with a halogenating agent in the presence of the supportive electron donor and/or internal electron donor. Halogenation converts the magnesium moiety present in the catalyst component into a magnesium halide support upon which the titanium halide (such as a titanium halide) is deposited. Not wishing to be bound by any particular theory, it is believed that during halogenation the internal electron donor (1) regulates the position of titanium on the magnesium-based support, (2) facilitates conversion of the magnesium and titanium moieties into respective halides and (3) regulates the crystallite size of the magnesium halide support during conversion.

In an embodiment, the halogenating agent is a titanium halide having the formula Ti(OR^{e})_{f}Xₕ wherein R^{e} and X are defined as above, f is an integer from 0 to 3; h is an integer from 1 to 4; and f+h is 4. In an embodiment, the halogenating agent is TiCl₄. In a further embodiment, the halogenation is conducted in the presence of a chlorinated or a non-chlorinated aromatic liquid, such as dichlorobenzene, o-chlorotoluene, chlorobenzene, benzene, toluene, or xylene. In yet another embodiment, the halogenation is conducted by use of a mixture of halogenating agent and chlorinated aromatic liquid comprising from 40 to 60 volume percent halogenating agent, such as TiCl₄.

The reaction mixture can be heated during halogenation. The catalyst precursor and halogenating agent are contacted initially at a temperature of less than about 10° C., such as less than about 0° C., such as less than about −10° C., such as less than about −20° C. The initial temperature is generally greater than about−50° C., such as greater than about −40° C. The mixture can be held at the initial temperature for a period of time, such as an hour, after contacting the catalyst precursor with the halogenating agent and is then heated at a rate of 0.1 to 10.0° C./minute, or at a rate of 1.0 to 5.0° C./minute. The internal electron donor may be added later, after an initial contact period between the halogenating agent and catalyst component. Temperatures for the halogenation are from 20° C. to 150° C. (or any value or subrange therebetween), or from 0° C. to 120° C.

The manner in which the halogenating agent, the supportive electron donor, and the internal electron donor are added may be varied in synthesizing the catalyst precursor. In an embodiment, the catalyst precursor is first contacted with a mixture containing the halogenating agent and a chlorinated aromatic compound. The resulting mixture is stirred and may be heated if desired. Next, the supportive electron donor and/or internal electron donor is added to the same reaction mixture without isolating or recovering of the precursor. The foregoing process may be conducted in a single reactor with addition of the various ingredients controlled by automated process controls.

In one embodiment, the catalyst component is contacted with the internal electron donor before reacting with the halogenating agent.

Contact times of the catalyst component with the supportive electron donor and/or internal electron donor are at least 10 minutes, or at least 15 minutes, or at least 20minutes, or at least 1 hour at a temperature from at least −30° C., or at least −20° C., or at least 10° C. up to a temperature of 150° C., or up to 120° C., or up to 115° C., or up to 110° C.

In one embodiment, the catalyst component, the supportive electron donor, the internal electron donor, and the halogenating agent are added simultaneously or substantially simultaneously. The halogenation procedure may be repeated one, two, three, or more times as desired.

The mono benzoate supportive donor contained in the catalyst precursor has the following formula:

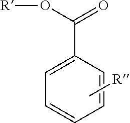

where R′ comprises an alkyl group, a cyclic group, an aryl group having from 1 to 20 carbon atoms, a heteroatom or a combination thereof, and wherein R″ comprises one or more substituted groups, each substituted group can comprise independently hydrogen, an alkyl group, a cyclic group, an aryl group having from 1 to 20 carbon atoms, a heteroatom, or a combination thereof. Illustrative mono benzoate supportive donors include methyl benzoate, ethyl benzoate, propyl benzoate, butyl benzoate, octyl benzoate, cyclohexyl benzoate, phenyl benzoate, benzyl benzoate, ethyl p-methoxybenzoate, methyl p-methyl benzoate, ethyl p-t-butyl benzoate, ethyl naphthoate, methyl toluate, ethyl toluate, amyl toluate, ethyl benzoate, methyl anisate, ethyl anisate, or ethyl ethoxybenzoate.

Various different types of internal electron donors may be incorporated into the solid catalyst component. In one embodiment, the internal electron donor is an aryl diester, such as a phenylene-substituted diester. In one embodiment, the internal electron donor may have the following chemical structure:

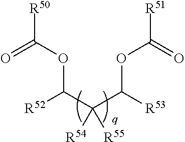

wherein: each of R⁵⁰, R⁵¹, R⁵², R⁵³, R⁵⁴, and R⁵⁵ are independently H, F, CI, Br, I, alkyl, cycloalkyl, cycloalkylalkyl, aryl, aralkyl, heterocyclyl, heterocyclylalkyl, heteroaryl, or heteroarylalkyl; and q is an integer from 0 to 12.

In one embodiment, the internal electron donor may have one of the following chemical structures:

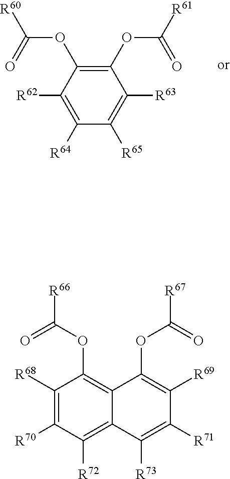

wherein: each of R⁶⁰ through R⁷³ are independently H, F, Cl, Br, I, alkyl, cycloalkyl, cycloalkylalkyl, aryl, aralkyl, heterocyclyl, heterocyclylalkyl, heteroaryl, or heteroarylalkyl; and q is an integer from 0 to 12.

In one embodiment the internal electron donor may have the following chemical structure:

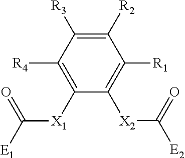

wherein R₁-R₄ are the same or different and each R₁-R₄ is selected from the group consisting of hydrogen, a substituted hydrocarboyl group having 1 to 20 carbon atoms, an a unsubstituted hydrocarobyl having 1 to 20 carbon atoms, a substituted or unsubstituted aryl group having 6 to 20 carbons, an alkoxy group having 1 to 20 carbon atoms, a heteroatom and combinations thereof and at least one of R1-R4 is not hydrogen; where E₁ and E₂ are the same or different and selected from the group consisting of an alkyl having 1 to 20 carbon atoms, including cycloalkyl groups having 5 to 10 carbon atoms, a substituted alkyl having 1 to 20 carbon atoms, an aryl having 6 to 20 carbon atoms, a substituted aryl having 6 to 20 carbon atoms, or an inert functional group having 1 to 20 carbon atoms and optionally containing heteroatoms; and wherein X₁ and X₂ are each O, S, an alkyl group, or NR₅ and wherein R₅ is a hydrocarbyl group having 1 to 20 carbon atoms or is hydrogen.

In one embodiment, R₁ and R₄ are each a saturated or unsaturated hydrocarbyl group having from 1 to 20 carbon atoms, at least one of R₂ and R₃ is hydrogen, at least one of R₂ and R₃ comprises a substituted or unsubstituted hydrocarbyl group having from 5 to 15 carbon atoms, the hydrocarbyl group having a branched or linear structure or comprising a cycloalkyl group having from 5 to 15 carbon atoms, such as from 7 to 15 carbon atoms, aryl and substituted aryl groups, E₁ and E₂ are the same or different and selected from the group consisting of an alkyl having 1 to 20 carbon atoms, a substituted alkyl having 1 to 20 carbon atoms, an aryl having 6 to 20 carbon atoms, a substituted aryl having 6 to 20 carbon atoms, or an inert functional group having 1 to 20 carbon atoms and optionally containing heteroatoms, and X₁ and X₂ are each O, S, an alkyl group or NR₅ and R₅ is a hydrocarbyl group having 1 to 20 carbon atoms or is hydrogen.

In one embodiment, R₁ and R₄ are identical or very similar. In one embodiment, for instance, R₁ and R₄ are linear hydrocarbyl groups. For instance, R₁ and R₄ may comprise a C₁ to C₈ alkyl group, a C₂ to C₈ alkenyl group, or mixtures thereof. For example, in one embodiment, R₁ and R₄ may both comprise alkyl groups that have the same carbon chain length or vary in carbon chain length by no more than about 3 carbons atoms, such as by no more than about 2 carbon atoms.

In one embodiment, R₄ is a methyl group, while R₁ is a methyl group, an ethyl group, a propyl group, or a butyl group, or vice versa. In another alternative embodiment, both R₁ and R₄ are methyl groups, both R₁ and R₄ are ethyl groups, both R₁ and R₄ are propyl groups, or both R₁ and R+are butyl groups.

In conjunction with the above described R₁ and R₄ groups, in one embodiment at least one of R₂ or R₃ is a substituted group that is larger or bulkier than the R₁ and R₄ groups. The other of R₂ or R₃ can be hydrogen. The larger or bulky group situated at R₂ or R₃, for instance, can be a hydrocarbyl group having a branched or linear structure or may comprise a cycloalkyl group having from 5 to 15 carbon atoms. The cycloalkyl group, for instance, may be a cyclopenyl group, a cyclohexyl group, a cycloheptyl group or a cyclooctyl group. When either R2 or R3 has a branched or linear structure, on the other hand, R₂ or R₃ may be a butyl group, a pentyl group, a heptyl group, an octyl group, a nonyl group, a decyl group, or the like. For instance, R₂ or R₃ may be a t-butyl group, 3-pentyl group or a 2-pentyl group.

Further examples of internal electron donors made in accordance with the present disclosure are shown below (Formulae I-XII). In each of the below structures, R₁ through R₄ can be substituted with any of the groups in any of the combinations described above.

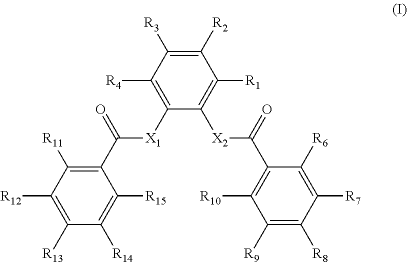

In Formula (I), R₆ through R₁₅ may be the same or different. Each of R₆ through R₁₅ may be selected from a hydrogen, substituted hydrocarbyl groups having 1 to 20 carbon atoms, and unsubstituted hydrocarbyl groups having 1 to 20 carbon atoms, an alkoxyl group having 1 to 20 carbon atoms, a hetero atom, and combinations thereof.

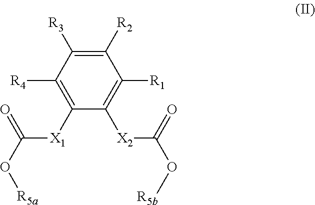

In Formula (II), X₁ and X₂ may be oxygen, sulfur, or a nitrogen containing group. In one embodiment, for instance, X₁ is oxygen and X₂ is sulfur. R₅a and R₅b may be independently alkyl groups or aryl groups. R^{a} and R₅b may be individually C₁ to C₈ alkyl groups in other embodiments.

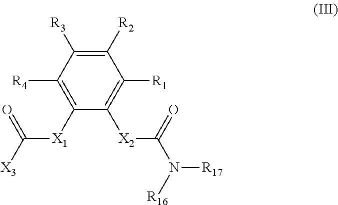

In Formula (III), R₁₆ and R₁₇ are independently hydrogen or a C₁ to C₂₀ hydrocarbyl group. In the above formula, X₁ and X₂ may be oxygen, sulfur, or a nitrogen group. Alternatively, one or both of X₁ and X₂ maybe a hydrocarbyl group, such as an alkyl group containing 1 to 3 carbon atoms. X₃ may be a —OR group or a —NR′R″ group in which R, R′, or R″ are independently a C₁ to C₂₀ hydrocarbyl group optionally containing a heteroatom selected from a halogen, phosphorous, sulfur, nitrogen, or oxygen. In one embodiment, X₁ is a carbon atom and X₃ is an ethyl group.

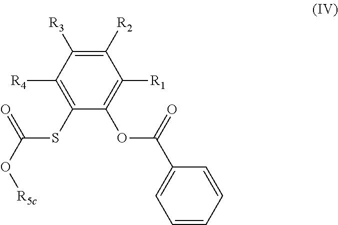

In Formula IV, R₅c may be an alkyl group or an aryl group. For example, R₅c may be a C₁ to C₈ alkyl group.

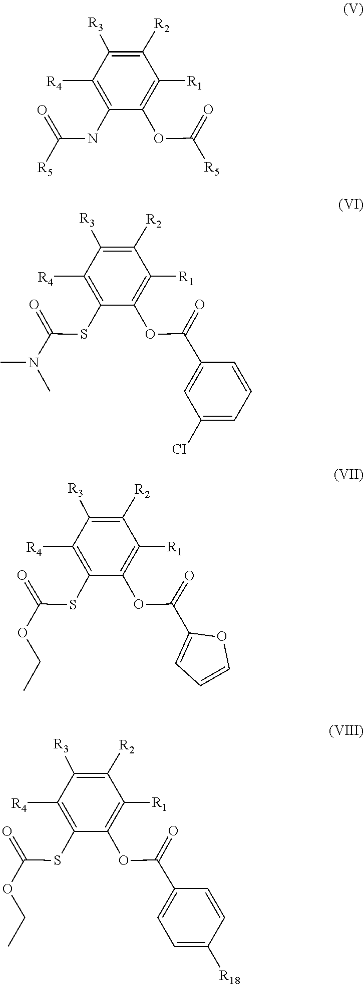

In the above Formulae, R₁₈ may be hydrogen or a hydrocarbyl group containing from about 1 to about 8 carbon atoms.

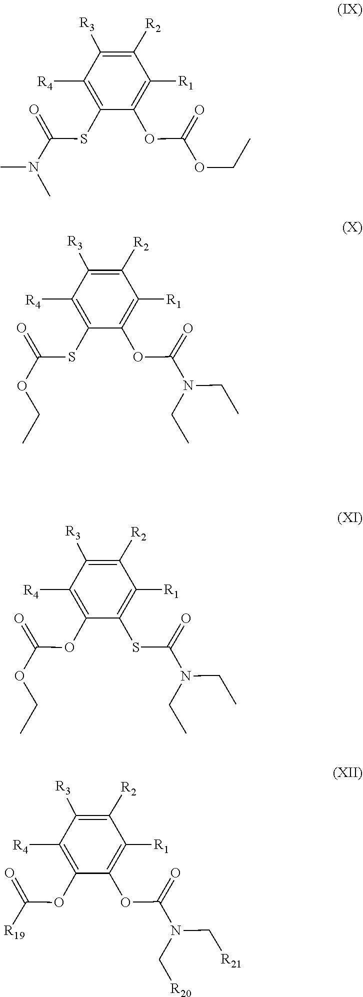

In the above Formulae, R₁₉, R₂₀, and R₂₁ may be the same or different and may be selected from a hydrocarbyl group having from about 1 to about 15 carbon atoms optionally containing a heteroatom selected from a halogen, phosphorous, sulfur, nitrogen, or oxygen. R₂₀ and R₂₁ can be the same or different and can be fused together to form 1 or more cyclic groups.

As used herein, the term “hydrocarbyl” and “hydrocarbon” refer to substituents containing only hydrogen and carbon atoms, including branched or unbranched, saturated or unsaturated, cyclic, polycyclic, fused, or acyclic species, and combinations thereof. Nonlimiting examples of hydrocarbyl groups include alkyl-, cycloalkyl-, alkenyl-, alkadienyl-, cycloalkenyl-, cycloalkadienyl-, aryl-, aralkyl, alkylaryl, and alkynyl-groups.

As used herein, the terms “substituted hydrocarbyl” and “substituted hydrocarbon” refer to a hydrocarbyl group that is substituted with one or more nonhydrocarbyl substituent groups. A nonlimiting example of a nonhydrocarbyl substituent group is a heteroatom. As used herein, a “heteroatom” refers to an atom other than carbon or hydrogen. The heteroatom can be a non-carbon atom from Groups IV, V, VI, and VII of the Periodic Table. Nonlimiting examples of heteroatoms include: halogens (F, Cl, Br, I), N, O, P, B, S, and Si. A substituted hydrocarbyl group also includes a halohydrocarbyl group and a silicon-containing hydrocarbyl group. As used herein, the term “halohydrocarbyl” group refers to a hydrocarbyl group that is substituted with one or more halogen atoms. As used herein, the term “silicon-containing hydrocarbyl group” is a hydrocarbyl group that is substituted with one or more silicon atoms. The silicon atom(s) may or may not be in the carbon chain.

The supportive donor is generally present in the catalyst component in an amount from about 0.5% to about 7% by weight, such as from about 2% to about 6% by weight, such as from about 3% to about 5.5% by weight. A portion of the supportive donor is generally removed from the catalyst component when the activity control agent is added. For example, from about 1% to about 20%, such as from about 4% to about 16% by weight of the mono benzoate supportive donor may be lost when the activity control agent is incorporated into the catalyst component compared to the amount of mono benzoate present in the catalyst precursor.

The internal donor is generally present in the catalyst component in an amount from about 3% to about 25%, such as from about 5% to about 12%, such as from about 8% to about 17%, such as from about 10% to about 15% by weight, such as from about 12% to about 14% by weight.

The catalyst component generally contains titanium in an amount from about 1% to about 10%, such as from about 1.5% to about 5%, such as from about 2% to about 4%, such as from about 2.5% to about 3.5% by weight. The catalyst component generally contains magnesium in an amount from about 10% to about 20%, such as from about 15% to about 18% by weight.

### B. Activity Control Agent

The catalyst component further contains an activity control agent. The activity control agent can be added to the catalyst precursor by mixing the catalyst precursor with the activity control agent in a hydrocarbon solvent. The catalyst component can then be filtered out.

For example, in one embodiment, the catalyst precursor is contacted with the activity control agent in a hydrocarbon solvent at a temperature from about 10° C. to about 40° C., such as from about 15° C. to about 35° C., such as from about 20° C. to about 30° C. The hydrocarbon solvent can include aromatic or non-aromatic solvents or combinations thereof. In certain embodiments, the aromatic hydrocarbon solvent is selected from toluene and C2-C20 alkylbenzene. In certain embodiments, the nonaromatic hydrocarbon solvent is a cycloalkyl compound, such as hexane.

The activity control agent can be added in an amount from about 0.01 to about 1.0 mol per mol of Ti, such as from about 0.05 to about 0.7 mol per mol of Ti, such as from about 0.08 to about 0.6 mol per mol of Ti, such as from about 0.1 to about 0.5 mol per mol of Ti. The activity control agent is generally present in the catalyst component in an amount from about 0.1% to about 20% by weight of the catalyst component.

The activity control agent can be (a) an organosilicon compound containing Si—O groups, (b) an organic ester from a C₄ to C₃₀ aliphatic acid ester or a poly(alkene glycol) ester of a C₄ to C₃₀ aliphatic acid, (c) an organo-aluminum compound containing an alkyl group, or a combination thereof.

The present inventors discovered that when the activity control agent is added to the catalyst precursor, it becomes chemically bonded to the halide-containing magnesium compound. In binding to the halide-containing magnesium compound, the ACA causes the partial removal of the supportive donor and causes a change in coordination between the internal donor and the halide-containing magnesium support.

Organosilicon compounds containing Si—O groups can be represented by the following chemical formula:

RₙSi(OR′)₄₋ₙ

where each R and R′ independently represent a hydrocarbon group, such as a hydrogen, alkyl, or aryl group, and n is 0≤n<4.

Specific examples of the organosilicon compound include, but are not limited to, trimethylmethoxysilane, trimethylethoxysilane, dimethyldimethoxysilane, dimethyldiethoxysilane, diisopropyldimethoxysilane, diisobutyldimethoxysilane, t-butylmethyldimethoxysilane, t-butylmethyldiethoxysilane, t-amylmethyldiethoxysilane, dicyclopentyldimethoxysilane, diphenyldimethoxysilane, phenylmethyldimethoxysilane, diphenyldiethoxysilane, bis-o-tolydimethoxysilane, bis-m-tolydimethoxysilane, bis-p-tolydimethoxysilane, bis-p-tolydiethoxysilane, bisethylphenyldimethoxysilane, dicyclohexyldimethoxysilane, cyclohexylmethyldimethoxysilane, cyclohexylmethyldiethoxysilane, ethyltrimethoxysilane, ethyltriethoxysilane, vinyltrimethoxysilane, methyltrimethoxysilane, n-propyltriethoxysilane, decyltrimethoxysilane, decyltriethoxysilane, phenyltrimethoxysilane, gamma-chloropropyltrimethoxysilane, methyltriethoxysilane, ethyltriethoxysilane, vinyltriethoxysilane, t-butyltriethoxysilane, n-butyltriethoxysilane, iso-butyltriethoxysilane, phenyltriethoxysilane, gamma-amniopropyltriethoxysilane, cholotriethoxysilane, ethyltriisopropoxysilane, vinyltirbutoxysilane, cyclohexyltrimethoxysilane, cyclohexyltriethoxysilane, 2-norbornanetrimethoxysilane, 2-norbornanetriethoxysilane, 2-norbornanemethyldimethoxysilane, ethyl silicate, butyl silicate, trimethylphenoxysilane, and methyltriallyloxysilane.

In one embodiment, the catalyst component contains an organosilicon

compound containing Si—O groups in an amount form about 0.1% to about 5% by weight, such as from about 0.2% to about 4% by weight, such as from about 0.15% to about 2% by weight of the catalyst component.

In another embodiment, the ACA is a C₄-C₃₀ aliphatic acid ester. Nonlimiting examples of suitable C₄-C₃₀ aliphatic acid esters include C₁₋₂₀ alkyl esters of aliphatic C₄₋₃₀ monocarboxylic acids, C₁₋₂₀ alkyl esters of aliphatic C₈₋₂₀ monocarboxylic acids, C₁₋₄ alkyl mono-and diesters of aliphatic C₄₋₂₀ monocarboxylic acids and dicarboxylic acids, C₁₋₄ alkyl esters of aliphatic C₈₋₂₀ monocarboxylic acids and dicarboxylic acids, and C₄₋₂₀ mono-or polycarboxylate derivatives of C₁₋₁₀₀ (poly) glycols or C₁₋₁₀₀ (poly) glycol ethers. In one embodiment, the C₄-C₃₀ aliphatic acid ester may be isopropyl myristate, pentyl valerate, and/or di-n-butyl sebacate.

In another embodiment, the activity control agent is a poly(alkylene glycol) ester. Nonlimiting examples of suitable poly(alkylene glycol) esters include poly(alkylene glycol) mono-or diacetates, poly(alkylene glycol) mono-or di-myristates, poly(alkylene glycol) mono-or di-laurates, poly(alkylene glycol) mono-or di-oleates, glyceryl tri (acetate), glyceryl tri-ester of C₂₋₄₀ aliphatic carboxylic acids, and any combination thereof. In an embodiment, the poly(alkylene glycol) moiety of the poly(alkylene glycol) ester is a poly(ethylene glycol).

When employed, the C₄-C₃₀ aliphatic acid ester or poly(alkylene glycol) ester of a C₄-C₃₀ aliphatic acid is present in the catalyst component in an amount from about 0.1% to about 15% by weight, such as form about 0.5% to about 14% by weight, such as from about 1% to about 12% by weight.

In one embodiment, the activity control agent is an organoaluminum compound containing an alkyl group. Examples of such organoaluminum compounds include those of the formula:

AlRₙX₃₋ₙ

wherein, R independently represents a hydrocarbon group usually having 1 to about 20 carbon atoms, X represents a halogen atom, and 0<n≤3.

Specific examples of the organoaluminum compounds include, but are not limited to, trialkyl aluminums such as triethyl aluminum, tributyl aluminum and trihexyl aluminum; trialkenyl aluminums such as triisoprenyl aluminum; dialkyl aluminum halides such as diethyl aluminum chloride, dibutyl aluminum chloride and diethyl aluminum bromide; alkyl aluminum sesquihalides such as ethyl aluminum sesquichloride, butyl aluminum sesquichloride and ethyl aluminum sesquibromide; alkyl aluminum dihalides such as ethyl aluminum dichloride, propyl aluminum dichloride and butyl aluminum dibromide; dialkyl aluminum hydrides such as diethyl aluminum hydride and dibutyl aluminum hydride; and other partially hydrogenated alkyl aluminum such as ethyl aluminum dihydride, and propyl aluminum dihydride.

When an organoaluminum compound is employed, it is generally present in the catalyst component in an amount from about 0.1% to about 5%, such as from about 0.15% to about 2%, such as from about 0.2% to about 1.5% by weight.

### C. Polymerization

The olefin polymerization method in accordance with the present disclosure is carried out in the presence of a catalyst system comprising a solid catalyst component as described herein, a cocatalyst, such as an organoaluminum compound, and optionally an external electron donor, such as an organosilicon compound. Generally speaking, olefins CH₂—CHR, where R is hydrogen or a hydrocarbon radical with 1-12 atoms, are contacted with the catalyst system under suitable conditions to form polymer products. The term polymerization as used in the present disclosure may include copolymerization such as random copolymerization or multi-step copolymerization as used to generate heterophasic copolymers. The polymerization process can be carried out according to known techniques, for example gas phase in fluidized bed or stirred bed reactors, slurry polymerization using an inert hydrocarbon solvent as diluent, or slurry polymerization using liquid monomer as reactant and diluent. The polymerization process can also be a combination or hybrid process, for example a bulk propylene liquid loop reactor connected to a gas phase reactor. The polymerization is generally carried out at a temperature from 20 to 120° C. and more preferably from about 50 to 90° C.

In one embodiment, the catalyst components, or a portion of the catalyst components, are precontacted before being fed to the polymerization reactor zone. The precontact step is typically conducted at higher concentration and lower temperature conditions than the polymerization reactor zone. In another embodiment the solid catalyst component can be fed to the reactor separately and contacted with the cocatalyst and external electron donor under polymerization conditions. An organoaluminum cocatalyst is preferably used in a molar amount of about 1-1000, preferably about 100-600, and more preferably about 45-300 relative to the moles of titanium in the procatalyst. An external electron donor is preferably used in a molar amount of about 0.005-1.0, and more preferably about 0.01-0.5 relative to the moles of organoaluminum cocatalyst. At high levels of external electron donor the ability to further reduce amorphous polypropylene, as measured by xylene solubles, diminishes and catalyst activity can decrease. Procatalysts of the present disclosure can reach a low xylene solubles level before the point of diminishing return feeding the external electron donor is reached. In some cases very low XS of 1% or less is achievable.

In an embodiment, a preliminary polymerization step (prepoly) takes place prior to the main polymerization. In another embodiment, the main polymerization is carried out without a prepoly step. When prepoly is used it can be conducted batch-wise and prepoly catalyst subsequently fed to the polymerization process. Alternatively, the catalyst can be fed to a continuous polymerization process and a prepoly step conducted as part of the process. Prepoly temperature is preferably in the range of −20 to +100° C., more preferably −20 to +80° C. and most preferably 0 to +40° C. It is possible to improve the catalytic activity, stereoselectivity, particle fragmentation, and resulting polymer morphology by conducting a prepoly step.

Hydrogen is typically added as chain transfer agent to control polymer molecular weight. Different polymerization processes have different limits on the amount of hydrogen that can be added to lower polymer molecular weight. Procatalysts of the present disclosure have increased sensitivity to hydrogen thus improving the molecular weight control capability of the process and expanding the types of polymer that can be produced.

The present disclosure may be better understood with reference to the following examples.

### EXAMPLES

The following parameters are defined as follows.

Catalyst particle morphology is indicative of the polymer particle morphology produced therefrom. The three parameters of polymer particle morphology (sphericity, symmetry and aspect ratio) may be determined using a Camsizer instrument. Camsizer Characteristics:

$$Spherecity SPHT = \frac{4 π A}{{P}^{2}} = Circularity 2 ( ISO 9276 - 6 )$$

P is the measured perimeter/circumference of a particle projection; and A is the measured area covered by a particle projection. For an ideal sphere, SPHT is defined as 1. Otherwise, the value is less than 1.

The symmetry is defined as:

$${Symm}_{0 , 3} = \frac{1}{2} ( 1 + min ( \frac{{r}_{1}}{{r}_{2}} ) )$$

where, rᵢ und r₂ are distance from the centre of area to the borders in the measuring direction. For asymmetric particles Symm is less than 1. If the centre of the area is outside the particle, i.e.

$$B / {L}_{0 , 2 , 3} = \frac{{x}_{c min}}{{x}_{Fe max}}$$

the Symm is less than 0.5 x_{Ma}=r₁+r₂, or “Symm,” is the minimum value of measured set of symmetry values from different directions.

Aspect ratio:

$$\frac{{r}_{1}}{{r}_{2}} < 0 ,$$

where x_{c min} and x_{Fe max out} of the measured set of x_{c} and x_{Fe} values.

The catalyst morphology characteristics such as aspect ratio (“B/L3”) can be used for characterization of polymer morphology.

“D₁₀” represents the size of particles (diameter), wherein 10% of particles are less than that size, “D₅₀” represents the size of particles, wherein 50% of particles are less than that size, and “D₉₀” represents the size of particles, wherein 90% of particles are less than that size. “Span” represents the distribution of the particle sizes of the particles. The value can be calculated according to the following formula:

Span=(D₉₀−D₁₀)/D₅₀
BD is an abbreviation for bulk density, and is reported in units of g/ml.
CE is an abbreviation for catalyst efficiency and is reported in units of Kg polymer per gram of catalyst (Kg/g) during the polymerization for 1 hour.
MFR is an abbreviation for melt flow rate and is reported in units of g/10 min. The MFR is measured cording to ASTM Test D1238 T.
EB is an abbreviation for ethyl benzoate.
Ti, Mg, and D are the weight percentages (wt %) for each of the titanium, magnesium, and internal donor, respectively, in the composition.
XS is an abbreviation for xylene solubles and is reported in units of wt %.
sl is an abbreviation for standard liter.

Example 1. Preparation of catalyst component (1) (comparative). MgCl₂ (13.2 g), toluene (59.5 g), tri-n-butylphosphate (36.3 g), and epichlorohydrin (14.25 g) were combined and heated to 60° C. with agitation at 600 rpm for 8 hours under a nitrogen atmosphere. Upon cooling to room temperature, toluene (140 g) was added, along with ethyl benzoate (3.5 g) and tetraethylorthosilicate (6 g). The mixture was then cooled to −25° C. and TiCl4 (261 g) was slowly added under 600 rpm stirring, while maintaining the temperature at −25° C. After the addition was complete, the temperature was maintained for 1 hour prior to warming to 35° C. over 30 minutes, at which it was held for 30 minutes, then the temperature was raised to 85° C. over 30 minutes and held for 30 minutes prior to collection of a solid precipitate via filtration. The solid precipitate was washed three times with toluene (200 ml, each wash). The resulting precipitate was then combined with toluene (264 ml). This mixture was heated under agitation to 105° C., followed by addition of an internal electron donor 2.4 g) in toluene (10 g). The internal electron donor was tert-butyl (3-methyl-5-t-butyl catechol dibenzoate) (CDB-1).

Heating at 105° C. was continued for 1 hour prior to collection of the solid via filtration. The process included combining with TiCl₄ in toluene and heating at 105° C. and again at 110° C., forming catalyst component (1). Catalyst component (1) was washed four times with hexane (200 ml, each wash), and agitating at 60-65° C. for 10 minutes for each wash.

Example 2. Preparation of catalyst component (2). 2.00 grams of dry catalyst component (1) was added to a 50 mL vial with a stirbar. 20 grams of hexane, and 0.295 g of 10% dicyclopentyldimethoxysilane (D-donor) were added at ambient temperature. The mixture was agitated for 1 hour at ambient temperature. The liquid was filtered and the solid was washed 3 times with hexane. The solid was dried, forming catalyst component (2).

Example 3. Preparation of catalyst component (3). 1.00 grams of dry catalyst component (1) was added to a 50 mL vial with a stirbar. 20 grams of hexane, and 4.29 g of 10% D-Donor were added at ambient temperature. The mixture was agitated for 1 hour at ambient temperature. The liquid was filtered and the solid was washed 3 times with hexane.

The solid was dried, forming catalyst component (3). The compositions of catalyst components 1-3 are provided in Table 1.

TABLE 1

| | | | | | | | ACA (D- |
|---|---|---|---|---|---|---|---|
| | Catalyst | | Ti, | Mg, | EB, | CDB-1, | donor), |
| Example | component | Condition | % | wt. % | wt. % | wt. % | wt. % |
| 1 | 1 | Non-treated | 3.55 | 17.16 | 6.11 | 9.70 | |
| (comparative) | | | | | | | |
| 2 | 2 | Cat. comp. 1 + 0.1 | 3.17 | 18.38 | 5.27 | 9.18 | 0.357 |
| | | mol D/mol Ti | | | | | |
| 3 | 3 | Cat. comp. 1 + 3.0 | 2.78 | 16.68 | 4.50 | 9.67 | 3.04 |
| | | mol D/mol Ti | | | | | |

As shown, the amount of the ethyl benzoate is reduced in examples 2 and 3 compared to the non-treated catalyst component (1) due to replacement by D-donor on the MgCl2 surface of the catalyst component. Increasing the amount of D-donor in example 3 resulted in more reduction of ethyl benzoate. The amount of internal donor CDB-1 did not change.

Examples 8-16 illustrate the preparation and composition of catalyst components containing CDB-2 as an internal donor, ethyl benzoate as a supportive donor, and either dicyclopentyldimethoxysilane (D-donor) or cyclohexylmethyldimethoxysilane (C-donor) as an ACA. The examples show a change of the catalyst component compositions after the treatment with ACA. For example, ACA partly replaces the supportive electron donor, while keeping the amount of internal electron donor CDB-2 the same in comparison with the catalyst component in comparative example 4.

Examples 4-7. Preparation of catalyst components (4-7) (comparative). Catalyst components 4, 5, 6, and 7 were prepared based on example 1 except CDB-2 was used as the internal donor (2.5-3.0 g) and the TiCl4 treatment condition was variable. CDB-2 is the catechol dibenzoate described in paragraph 52 of U.S. Patent Application Publication No. 2013/0261273, which is incorporated herein by reference.

Example 8. Preparation of catalyst component (8). Catalyst component (4) was treated with D-donor in an amount of 0.1 mol per mol Ti under the conditions described in example 2.

Example 9. Preparation of catalyst component (9). The catalyst component (4) was treated with D-donor in an amount of 0.5 mol per mol Ti under the conditions described in example 2. The compositions of catalyst components 4, 8, and 9 are provided in Table 2.

TABLE 2

| | | | | | | | ACA |
|---|---|---|---|---|---|---|---|
| | Catalyst | | Ti, | Mg, | EB, | CDB-2, | (D-donor), |
| Example | component | Condition | wt. % | wt. % | wt. % | wt. % | wt. % |
| 4 (comparative) | 4 | Non-treated | 3.1 | 15.74 | 4.08 | 12.28 | |
| 8 | 8 | Cat. comp. 4 + 0.1 | 3.06 | 16.19 | 3.89 | 12.21 | 0.17 |
| | | mol D/mol Ti | | | | | |
| 9 | 9 | Cat. comp. 4 + 0.5 | 2.77 | 15.57 | 3.35 | 12.34 | 1.42 |
| | | mol D/mol Ti | | | | | |

Example 10. Preparation of catalyst component (10). Catalyst component (5) was treated with D-donor in an amount of 0.1 mol per mol Ti under the conditions described in example 2.

Example 11. Preparation of catalyst component (11). Catalyst component (5) was treated with D-donor in an amount of 0.2 mol per mol Ti under the conditions described in example 2. The compositions of catalyst components 5, 10, and 11 are provided in Table 3.

TABLE 3

| | | | | | | EB | | ACA |
|---|---|---|---|---|---|---|---|---|
| | Catalyst | | Ti, | Mg, | EB, | Loss, | CDB-2, | (D-donor), |
| Example | component | Condition | wt. % | wt. % | wt. % | wt. % | wt. % | wt. % |
| 5 | 5 | Non-treated | 3.23 | 18.11 | 5.45 | | 13.5 | 0 |
| (comparative) | | | | | | | | |
| 10 | 10 | Cat. comp. 5 + 0.1 | 2.65 | 16.18 | 4.81 | 11.7 | 13.4 | 0.62 |
| | | mol D/mol Ti | | | | | | |
| 11 | 11 | Cat. comp. 5 + 0.2 | 2.74 | 16.83 | 4.61 | 15.4 | 13.5 | 1.17 |
| | | mol D/mol Ti | | | | | | |

Example 12. Preparation of catalyst component (12). Catalyst component (6) was treated with D-donor in an amount of 0.1 mol per mol Ti under the conditions described in example 2.

Example 13. Preparation of catalyst component (13). Catalyst component (6) was treated with cyclohexylmethyldimethoxysilane (C-donor) in an amount of 0.1 mol per mol Ti under the conditions described in example 2. The compositions of catalyst components 6, 12, and 13 are provided in Table 4.

TABLE 4

| | | | | | | EB | | |
|---|---|---|---|---|---|---|---|---|
| | Catalyst | | Ti, | Mg, | EB, | Loss, | CDB-2, | ACA (D- |
| Example | component | Condition | wt. % | wt. % | wt. % | wt. % | wt. % | donor), wt. % |
| 6 (comparative) | 6 | Non-treated | 3.43 | 16.51 | 5.88 | | 12.9 | 0 |
| 12 | 12 | Cat. comp. 6 + 0.1 | 2.93 | 14.86 | 5.33 | 9.4 | 13.0 | 0.64 |
| | | mol D/mol Ti | | | | | | |
| 13 | 13 | Cat. comp. 6 + 0.1 | 3.20 | 16.04 | 5.17 | 12.1 | 12.9 | n/a |
| | | mol C/mol Ti | | | | | | |

Example 14. Preparation of catalyst component (14). Catalyst component (7) was treated with D-donor in an amount of 0.1 mol per mol Ti under the conditions described in example 2.

Example 15. Preparation of catalyst component (15). Catalyst component (7) was treated with D-donor in an amount of 0.15 mol per mol Ti under the conditions described in example 2.

Example 16. Preparation of catalyst component (16). Catalyst component (7) was treated with C-donor in an amount of 0.1 mol per mol Ti under the conditions described in example 2. The compositions of catalyst components 7, 14, 15, and 16 are provided in Table 5.

TABLE 5

| | | | | | | EB | | |
|---|---|---|---|---|---|---|---|---|
| | Catalyst | | Ti, | Mg, | EB, | Loss, | CDB-2, | ACA (D- |
| Example | component | Condition | wt. % | wt. % | wt. % | wt. % | wt. % | donor), wt. % |
| 7 (comparative) | 7 | Non-treated | 2.92 | 17.41 | 5.34 | | 12.5 | 0 |
| 14 | 14 | Cat. comp. 7 + | 2.69 | 17.12 | 5.15 | 4.7 | 13.2 | 0.58 |
| | | 0.1 mol D/mol | | | | | | |
| | | Ti | | | | | | |
| 15 | 15 | Cat. comp. 7 + | 2.53 | 16.70 | 4.68 | 14.1 | 12.7 | 0.85 |
| | | 0.15 mol | | | | | | |
| | | D/mol Ti | | | | | | |
| 16 | 16 | Cat. comp. 7 + | 2.55 | 16.59 | 4.92 | 7.9 | 12.7 | n/a |
| | | 0.1 mol C/mol | | | | | | |
| | | Ti | | | | | | |

Example 17. Preparation of catalyst component 17 (comparative). Catalyst component (17) was prepared based on example 1 with the addition of a second electron donor, diether (3,3-bis(methoxymethyl)-2,6-dimethylheptane) (DEMH) and the amount of CDB-1 was reduced.

Example 18. Preparation of catalyst component (18). Catalyst component (17) was reacted with D-donor under the conditions described in example 2.

TABLE 6

| | Catalyst | | Ti, | Mg, | EB, | CDB, | DEMH, | ACA (D-donor), |
|---|---|---|---|---|---|---|---|---|
| Example | component | Condition | wt. % | wt. % | wt. % | wt. % | wt. % | wt. % |
| 17 (comparative) | 17 | CDB | 2.80 | 17.97 | 3.25 | 3.83 | 10.75 | 0 |
| | | (0.075) + | | | | | | |
| | | DEMH | | | | | | |
| | | (0.175) | | | | | | |
| 18 | 18 | Cat. comp. | 2.55 | 17.17 | 3.05 | 3.74 | 9.26 | 0.25 |
| | | 17 + 0.1 mol | | | | | | |
| | | D/mol Ti | | | | | | |

Example 19. Catalyst component (19) (comparative). CONSISTA® catalyst component available from W.R. Grace was used as catalyst component 19.

Example 20. Preparation of the catalyst component (20). Catalyst component (19) was treated with D-donor under the conditions described in example 2.

### Bulk Propylene Polymerization

The catalyst components of the above examples were used to produce polypropylene. The following method was used. The reactor was baked at 100° C. under nitrogen flow for 30 minutes prior to the polymerization run. The reactor was cooled to 30-35° C. and cocatalyst (1.5 ml of 25 wt % triethylaluminum (TEAl)), C-donor (cyclohexylmethydimethoxysilane) (1 ml), hydrogen (3.5 psi) and liquid propylene (1500 ml) were added in this sequence into the reactor. The catalyst (5-10 mg), loaded as a mineral oil slurry, was pushed into the reactor using high pressure nitrogen. Polymerization was performed for one hour at 70° C. After polymerization, the reactor was cooled to 22° C., vented to atmospheric pressure, and the polymer was collected.

The bulk polymerization results for the first and second hours of

polymerization were used to compare the catalyst performance of the treated and non-treated catalysts. The catalyst activity in the 1st and 2nd hours of polymerization were calculated based on the yielded polymer collected during each hour.

The examples in Tables 7-11 demonstrate the catalyst components' performances in propylene polymerization. The performances of the catalyst components are compared with comparative examples prepared without an ACA. The catalyst activities were measured during the first and second hour of polymerization. The results in the tables show that the catalyst activities of the catalysts with an ACA are reduced in the first hour but remain high and steady through the second hour of polymerization compared to the comparative catalyst components. The reduction in activities of the catalysts with ACAs is variable and depends on the nature of the catalyst component and the ACA used. A strong effect of D-donor on catalyst lifetime was observed in comparison with C-donor. The amount of ACA used in the preparation of each catalyst component affects the catalyst activity. For example, the catalyst activity in both the first and the second hours is reduced with increasing amounts of ACA.

The observed improvement of the catalyst lifetime might be explained by the fact that coordination of the ACA on the MgCl2 surface of the catalyst changes the coordination of the internal donor around Ti-active centers, partly deactivating very active catalytic centers and making the catalyst lifetime longer for the second hour of the polymerization process.

TABLE 7

| | Catalyst | | | | MFR, g/10 | | | |
|---|---|---|---|---|---|---|---|---|
| Example | component | Hour | CE, kg/g/h | BD, g/ml | min | XS, wt. % | PP D50, μm | Span |
| 21 | 1 | 1 | 72.2 | 0.419 | 1.39 | 2.47 | 710 | 0.839 |
| (comparative) | | | | | | | | |
| | 1 | 2 | 44.1 | 0.441 | 3.31 | 3.22 | 854 | 0.816 |
| 22 | 2 | 1 | 72.4 | 0.429 | 0.38 | 1.81 | 515 | 0.484 |
| | 2 | 2 | 50.6 | 0.443 | 1.30 | 2.23 | 625 | 0.496 |

TABLE 8

| | Catalyst | | CE, | BD, | MFR, | XS, | D-50, | | |
|---|---|---|---|---|---|---|---|---|---|
| Example | component | Hour | kg/g/h | g/ml | g/10 min | wt. % | μm | Span | b/l3 |
| 23 | 4 | 1 | 105.2 | 0.454 | 1.36 | 2.13 | 611 | 0.676 | 0.734 |
| (comparative) | | 2 | 78.8 | 0.485 | 2.11 | 2.04 | 725 | 0.652 | 0.738 |
| 24 | 8 | 1 | 84.4 | 0.440 | 0.31 | 1.56 | 556 | 0.514 | 0.764 |
| | | 2 | 70.4 | 0.460 | 2.33 | 2.37 | 707 | 0.727 | 0.725 |
| 25 | 9 | 1 | 39.8 | 0.426 | 6.00 | 2.26 | 612 | 1.443 | 0.697 |
| | | 2 | 37.4 | 0.465 | 12.66 | 2.44 | 586 | 0.981 | 0.737 |

TABLE 9

| | Catalyst | | CE, | BD, | MFR, | XS, | D-50, | |
|---|---|---|---|---|---|---|---|---|
| Example | component | Hour | kg/g/h | g/ml | g/10 min | wt. % | μm | b/l3 |
| 26 | 5 | 1 | 92.2 | 0.430 | 0.79 | 2.00 | 1014 | 0.753 |
| (comparative) | | 2 | 65.5 | 0.436 | 6.51 | 2.59 | 1200 | 0.758 |
| 27 | 10 | 1 | 88.2 | 0.409 | 0.42 | 1.81 | 989 | 0.761 |
| | | 2 | 78.1 | 0.424 | 4.99 | 2.19 | 1235 | 0.760 |
| 28 | 11 | 1 | 82.8 | 0.410 | 1.31 | 1.86 | 987 | 0.754 |
| | | 2 | 65.5 | 0.429 | 5.86 | 2.40 | 1189 | 0.763 |

TABLE 10

| | Catalyst | | CE, | BD, | MFR, | XS, | D-50, | |
|---|---|---|---|---|---|---|---|---|
| Example | component | Hour | kg/g/h | g/ml | g/10 min | wt. % | μm | b/l3 |
| 29 | 6 | 1 | 102.0 | 0.385 | 0.38 | 1.99 | 1045 | 0.731 |
| (comparative) | | 2 | 76.0 | 0.426 | 4.02 | 2.51 | 1345 | 0.738 |
| 30 | 12 | 1 | 93.8 | 0.418 | 0.43 | 2.09 | 985 | 0.734 |
| | | 2 | 90.2 | 0.426 | 3.08 | 2.47 | 1240 | 0.766 |
| 31 | 13 | 1 | 98.0 | 0.413 | 1.12 | 2.42 | 1025 | 0.747 |
| | | 2 | 78.3 | 0.431 | 5.82 | 2.82 | 1265 | 0.710 |

TABLE 11

| | Catalyst | | CE, | BD, | MFR, | XS, | D-50, | |
|---|---|---|---|---|---|---|---|---|
| Example | component | Hour | kg/g/g | g/ml | g/10 min | wt. % | μm | b/l3 |
| 32 | 19 | 1 | 89.4 | 0.386 | 0.17 | 1.93 | 1261 | 0.708 |
| (comparative) | | 2 | 68.9 | 0.397 | 0.94 | 2.21 | 1543 | 0.710 |
| 33 | 20 | 1 | 85.4 | 0.381 | 0.15 | 1.49 | 1157 | 0.709 |
| | | 2 | 75.0 | 0.392 | 0.79 | 2.08 | 1469 | 0.733 |

Example 34. Preparation of catalyst components containing aluminum (catalyst components 21-27). Catalyst component (4) was treated with various amounts of Et₃Al and D-donor. The amounts of ACA used and the compositions of the resulting catalysts are shown in Error! Reference source not found. As shown, the amount of the supportive donor (ethyl benzoate) is reduced in comparison with catalyst component (4) and the catalyst components contain aluminum.

TABLE 12

| Catalyst | Condition | Ti, | Mg, | Al, | EB, | CDB-2, | D-donor, |
|---|---|---|---|---|---|---|---|
| component | (Ti/D/TEA1) | wt. % | wt. % | wt. % | wt. % | wt. % | wt. % |
| 21 | 1/0/0.1 | 3.17 | 15.53 | 0.20 | 3.31 | 12.3 | 0 |
| 22 | 1/0/0.4 | 3.08 | 15.28 | 0.67 | 3.09 | 11.7 | 0 |
| 23 | 1/0/0.5 | 2.99 | 15.46 | 0.97 | 3.73 | 12.11 | 0 |
| 24 | 1/0/0.6 | 3.28 | 16.02 | 1.28 | 3.44 | 12.36 | 0 |
| 25 | 1/0/1.0 | 3.18 | 15.63 | n/a | 3.06 | 13.98 | 0 |
| 26 | 1/0.1/0.1 | 3.06 | 15.56 | 0.16 | 3.21 | 12.4 | 0.64 |
| 27 | 1/0.1/0.3 | 3.14 | 15.52 | 0.67 | 3.42 | 12.2 | 0.68 |

Examples 35-41. Polymerization with catalyst components containing aluminum. Catalyst components 21-27 were tested similarly to Examples 21-33. The results are shown in Table 13.

Examples 35-39 demonstrate the catalyst performance with catalyst components containing different amounts of Al, which resulted in different distributions of the catalyst activity during the 1^{st} and 2^{nd} hours of polymerization. These examples show better distribution of the catalyst activity and improved polymer morphology (bulk density, and sphericity data) compared to comparative example 23.

Examples 40 and 41 demonstrate the catalyst performance with catalyst components (26) and (27) containing two ACAs: D-donor and TEAl.

TABLE 13

| | Cat. | Condition | | CE, | BD, | MFR, | XS, | | | |
|---|---|---|---|---|---|---|---|---|---|---|
| Example | Comp. | (Ti/D/TEA1) | Hour | kg/g/h | g/ml | g/10 min | wt.% | SPHT3 | Symm3 | b/l3 |
| 35 | 21 | 1/0/0.1 | 1 | 97.6 | 0.447 | 0.60 | 1.59 | 0.867 | 0.899 | 0.763 |
| | 21 | 1/0/0.1 | 2 | 71.2 | 0.456 | 5.49 | 2.33 | 0.867 | 0.900 | 0.761 |
| 36 | 22 | 1/0/0.4 | 1 | 89.0 | 0.456 | 0.92 | 1.97 | 0.857 | 0.891 | 0.750 |
| | 22 | 1/0/0.4 | 2 | 77.6 | 0.460 | 6.72 | 2.33 | 0.858 | 0.893 | 0.748 |
| 37 | 23 | 1/0/0.5 | 1 | 93.2 | 0.458 | 0.92 | 2.09 | 0.854 | 0.893 | 0.753 |
| | 23 | 1/0/0.5 | 2 | 80.5 | 0.468 | 4.93 | 2.47 | 0.859 | 0.895 | 0.755 |
| 38 | 24 | 1/0/0.6 | 1 | 88.8 | 0.457 | 1.50 | 1.99 | 0.828 | 0.874 | 0.732 |
| | 24 | 1/0/0.6 | 2 | 75.5 | 0.468 | 6.31 | 2.24 | 0.846 | 0.886 | 0.743 |
| 39 | 25 | 1/0/1.0 | 1 | 80.0 | 0.455 | 1.33 | 2.04 | n/a | n/a | 0.748 |
| | 25 | 1/0/1.0 | 2 | 68.3 | 0.460 | 6.70 | 2.54 | 0.828 | 0.877 | 0.736 |
| 40 | 26 | 1/0.1/0.1 | 1 | 85.8 | 0.438 | 0.45 | 1.66 | 0.838 | 0.885 | 0.744 |
| | 26 | 1/0.1/0.1 | 2 | 75.9 | 0.448 | 2.66 | 1.71 | 0.859 | 0.897 | 0.758 |
| 41 | 27 | 1/0.1/0.3 | 1 | 83.8 | 0.400 | 1.89 | 2.02 | 0.813 | 0.872 | 0.729 |
| | 27 | 1/0.1/0.3 | 2 | 56.2 | 0.412 | 8.00 | 2.24 | 0.824 | 0.881 | 0.738 |

Examples 42-58. Two types of spherical catalyst components with an ACA were prepared and tested. The first type, used in examples 42-50, was made with supports made using an emulsion method as described in U.S. Patent Application Publication No. 2020/0283553. Catalyst components 29-31 used the support in combination with an ACA and CDB-2 as an internal donor.

Example 42. Spherical catalyst component (28) (comparative). The spherical catalyst component (28) was made based on magnesium alkoxide as described in U.S. Patent Application Publication No. 2020/0283553.

Example 43. Preparation of spherical catalyst component (29). Catalyst component (28) was treated with D-donor as described in example 2 with Ti/D=0.1.

Example 44. Preparation of spherical catalyst component (30). Catalyst component (28) was treated with D-donor as described in example 2 with Ti/D=0.2.

Example 45. Preparation of spherical catalyst component (31). Catalyst component (28) was treated with EtAl (Ti/Al=0.5). The compositions of catalyst components 28-31 are provided in Table 14.

Examples 46-48. Examples 47 and 48 demonstrate bulk propylene polymerization with spherical catalyst components (29) and (31). The examples showed improved bulk density of polymer particles produced with these catalysts in comparison with example 46. The results are provided in Table 15.

TABLE 14

| | Catalyst | | Ti, | Mg, | EB, | CDB-2, | ACA, |
|---|---|---|---|---|---|---|---|
| Example | component | Condition | wt. % | wt. % | wt. % | wt. % | wt. % |
| 42 | 28 | Non-treated | 2.25 | 17.24 | 3.34 | 12.89 | 0 |
| (comparative) | | | | | | | |
| 43 | 29 | Ti/D = 1/0.1 | 2.16 | 17.92 | 3.41 | 12.75 | |
| 44 | 30 | Ti/D = 1/0.2 | 2.07 | 17.50 | 3.16 | 12.45 | |
| 45 | 31 | Ti/Al = 1/0.5 | 2.39 | 16.91 | 2.84 | 12.82 | 0.49 |

TABLE 15

| | Cat. | CE | MFR, | BD, | XS, | D50, | | | |
|---|---|---|---|---|---|---|---|---|---|
| Example | Comp. | kg/g | g/10 min | g/ml | wt. % | μm | SPHT3 | Symm3 | b/l3 |
| 46 | 28 | 72.4 | 3.93 | 0.436 | 1.84 | 1171 | 0.918 | 0.916 | 0.830 |
| (comparative) | | | | | | | | | |
| 47 | 29 | 75.4 | 5.45 | 0.446 | 1.80 | 1171 | 0.904 | 0.916 | 0.828 |
| 48 | 31 | 65.0 | 8.77 | 0.461 | 1.75 | 1005 | 0.899 | 0.916 | 0.826 |

Examples 49 and 50. In Example 50, catalyst component (31) was tested using a “stress test” wherein the catalyst is injected into the polymerization reactor at 60° C. to compare the catalyst performance without pre-poly stage. The bulk density of polymer particles produced under these conditions are compared with catalyst component (28) (comparative example 49).

TABLE 16

| | Catalyst | Charge | CE, | BD, | MFR. | XS, | D50, | | |
|---|---|---|---|---|---|---|---|---|---|
| Example | component | Temp, ° C. | kg/g | g/ml | g/10 min | wt. % | μm | Span | b/l3 |
| 49 (comparative) | 28 | 60 | 94.4 | 0.385 | 1.84 | 1.44 | 1418 | 0.490 | 0.877 |
| 50 | 31 | 60 | 63.2 | 0.412 | 4.14 | 1.65 | 1095 | 0.642 | 0.870 |

The second type of spherical catalyst, used in examples 51-58, was prepared based on a spherical MgCl2nEtOH support with CDB-2 as an internal donor.

Example 51. Spherical catalyst component (32) (comparative). Spherical catalyst component (32) was made based on spherical MgCl2n nEtOH and CDB-2 as described in PCT publication WO 2021/055430, which is incorporated herein by reference.

Example 52. Preparation of spherical catalyst components (33) and (34). Catalyst component (33): catalyst component 32 was treated with D-donor (Ti/D=1.0/0.2) as described in example 2. Catalyst component (34): catalyst component 32 was treated with Et3Al (Ti/Al=1.0/0.8) in hexane at ambient temperature for 1 hour. The solid was washed with hexane and dried. Catalyst components (33) and (34) were tested in standard bulk propylene polymerization with precontact and pre-poly steps (Table 17) and under the “stress” test described above (Table 18). The catalyst performance was compared with comparative catalyst component (32) which contains no ACA.

Examples 54, 55, 57 and 58 demonstrate improvement of bulk density and sphericity of polymer produced with catalyst components made with D-donor and Et3 Al.

TABLE 17

| | Catalyst | CE, | MFR, | BD, | XS, | D50, | |
|---|---|---|---|---|---|---|---|
| Example | component | kg/g | g/10 min | g/ml | wt. % | μm | b/l3 |
| 53 | 32 | 86.0 | 3.47 | 0.413 | 3.00 | 1760 | 0.870 |
| (comparative) | | | | | | | |
| 54 | 33 | 66.7 | 4.84 | 0436 | 2.25 | 1644 | 0.881 |
| 55 | 34 | 81.2 | 2.62 | 0.439 | 3.30 | 1706 | 0.880 |

TABLE 18

| | | Charge | | | | | | | | | |
|---|---|---|---|---|---|---|---|---|---|---|---|
| | Catalyst | Temp, | CE | BD, | MFR, | XS, | D50, | | | | |
| Example | component | ° C. | kg/g | g/ml | g/10 min | wt. % | μm | Span | SPHT3 | Symm3 | b/l3 |
| 56 | 32 | 60 | 88.0 | 0.342 | 2.1 | 2.15 | 1717 | 0.793 | 0.893 | 0.910 | 0.818 |
| (comparative | | | | | | | | | | | |
| 57 | 33 | 60 | 63.6 | 0.376 | 2.96 | 2.23 | 1455 | 0.786 | 0.937 | 0.930 | 0.862 |
| 58 | 34 | 60 | 81.2 | 0.380 | 3.55 | 2.60 | 1737 | 0.692 | 0.927 | 0.924 | 0.851 |

Examples 59-63. Another ACA, iso-propylmyristate (IPM), was used.

Example 59. Preparation of catalyst component (35). Example 1 was repeated with addition of isopropyl myristate (IPM) (3.0 g) before CDB-1 was added.

Example 60. Preparation of catalyst component (36). Example 1 was repeated with addition of isopropyl myristate (IPM) (3.0 g) at the last stage of TiCl4 treatment.

Example 61. Preparation of catalyst component (37). Example 4 was repeated with addition of isopropyl myristate (IPM) (3.0 g) at the last stage of TiCl4 treatment.

Example 62. Preparation of catalyst component (38). Catalyst component (6) (3.00 g) was treated with IPM (0.525 g) in hexane at ambient temperature for 1 hour. The solid was washed with hexane and dried.

Example 63. Preparation of catalyst component (39). Catalyst component (27) (1.00 g) was treated with D-donor (0.143 g of 10% solution in hexane) in hexane at ambient temperature for 1 hour. The solid was washed with hexane and dried.

Examples 64-66. Catalyst components (35)-(39) were tested in bulk propylene polymerization to evaluate the catalyst activity in the first and second hours of polymerization. Examples 64 and 65 demonstrate polymerization with catalyst components (35) and (36) containing CDB-1 and ethyl benzoate prepared with IPM as the ACA. It was found that the method of impregnation of IPM affects the catalyst activity during the first and second hour of polymerization. For example, Example 65 shows dramatic improvement of polymerization kinetics with higher catalyst activity in the second hour than in in the first hour. Example 21 can be used as a comparative example, where higher catalyst activity is observed in the first hour of polymerization.

The catalyst components (37) and (38) containing CDB-2, ethyl benzoate and IPM prepared by different methods exhibit different polymerization behaviors. Example 66 with catalyst component (34) demonstrates high catalyst activity in first and second hours of polymerization with almost flat kinetics compared with comparative example 29.

Catalyst component (39) was prepared with two ACAs: D-donor and IPM. Example 58 demonstrates polymerization behavior of catalyst component (39), showing a reduction in catalyst activity but keeping a higher catalyst activity in second hour of polymerization than in the first hour, which provides a benefit to multi-reactor polymerization process.

TABLE 17

| | Catalyst | | Ti, | Mg, | EB, | CDB-1, | CDB-2, | ACA, |
|---|---|---|---|---|---|---|---|---|
| Example | component | Condition | wt. % | wt. % | wt. % | wt. % | wt. % | wt. % |
| 59 | 35 | IPM before | 3.44 | 18.43 | 4.40 | 9.2 | | 0 |
| | | CDB-1 | | | | | | |
| 60 | 36 | IPM in last | 3.63 | 17.01 | 4.90 | 9.6 | | 1.25 |
| | | TiCl₄ | | | | | | |
| | | treatment | | | | | | |
| 61 | 37 | IPM in last | 3.02 | 15.84 | 2.86 | | 13.9 | 2.23 |
| | | TiCl₄ | | | | | | |
| | | treatment | | | | | | |
| 62 | 38 | IPM before | 2.43 | 14.39 | 2.99 | | 14.3 | 14.6 |
| | | CDB-2 | | | | | | |
| 63 | 39 | IPM + D | 2.14 | 13.94 | 2.66 | | 13.62 | 11.4 |

TABLE 18

| | Catalyst | | CE, | BD, | MFR, | XS, |
|---|---|---|---|---|---|---|
| Example | component | Hour | kg/g/h | g/ml | g/10 min | wt. % |
| 64 | 35 | 1 | 70.2 | 0.412 | 2.27 | 2.38 |
| | 35 | 2 | 44.2 | 0.431 | 11.17 | 3.26 |
| 65 | 36 | 1 | 74.4 | 0.439 | 1.43 | 2.04 |
| | 36 | 2 | 98.2 | 0.426 | 2.30 | 2.39 |
| 66 | 37 | 1 | 114.0 | 0.426 | 1.19 | 2.04 |
| | 37 | 2 | 117.0 | 0.431 | 12.08 | 2.55 |
| 67 | 38 | 1 | 87.4 | 0.424 | 3.76 | 2.05 |
| | 38 | 2 | 68.6 | 0.424 | 16.79 | 2.22 |
| 68 | 39 | 1 | 70.4 | 0.417 | 7.34 | 2.19 |
| | 39 | 2 | 82.9 | 0.424 | 22.38 | 3.11 |

Catalyst components with ACA to control catalyst activity at high polymerization temperature are described in examples 69-70. A reduction of catalyst activity at high polymerization temperatures (self-extinguishing property) is an important catalyst characteristic to prevent uncontrolled polymerization and plugging of the polymerization reactor.

It was found that the ACAs described herein, such as organic esters of C4 to C30 aliphatic acids, poly(alkene glycol) esters of C4 to C30 aliphatic acids, organosilicon compounds and alkyl aluminum compounds, can also provide self-extinguishing properties. The ACAs can be used alone or in combination to achieve this effect. For example, as shown below, C4 to C30 aliphatic acids or poly(alkene glycol) esters of a C4 to C30 aliphatic acids can be used alone as ACAs to demonstrate the self-extinguishing properties.

Examples of catalyst component preparation containing isopropyl myristate are described in examples 35-39.

Catalyst component 40 containing pentyl valerate (PV) is prepared under the same procedure as catalyst component 35 except PV (0.23 g per 1 g of MgCl₂ ) is used instead IPM.

The catalyst components containing a benzoate supportive donor and an internal donor show some self-extinguishing properties: reduction of catalyst activity at high temperature of polymerization. However, it was observed that a combination of a benzoate supportive donor, an internal donor, and an ACA in the catalyst component increases the self-extinguishing property of the catalysts.

To test the self-extinguishing properties, polymerization was conducted in a bulk propylene polymerization reactor for 30 minutes at 70, 80 and 90° C. The ratio of the catalyst activity at 90° C. and 80° C. was used to compare the self-extinguishing properties of the catalysts.

Examples 69-70 illustrate the catalyst component behavior at high polymerization temperature (Table 19). Example 69 uses catalyst component 1 and Example 70 uses catalyst component 40, which contains PV as an ACA. Example 70 shows a higher reduction (15%) of catalyst activity at 90° C. compared to Example 69.

TABLE 19

| | | | | Si/Ti | | Run | | | MFR. | | % reduction |
|---|---|---|---|---|---|---|---|---|---|---|---|
| | Catalyst | | External | mol | | temp, | CE, | BD, | g/10 | XS, | from 80 to |
| Example | component | ACA | Donor | ratio | H₂ (sl) | ° C. | kg/g/h | g/ml | min | wt. % | 90° C. |
| 69 | 1 | — | D | 15 | 7 | 70 | 66.2 | 0.462 | 0.80 | 2.15 | |
| | 1 | — | D | 15 | 7 | 80 | 73.6 | 0.467 | 0.15 | 1.85 | |
| | 1 | — | D | 15 | 7 | 90 | 66.4 | 0.451 | 2.14 | 2.11 | 9.8 |
| 70 | 40 | PV | D | 15 | 7 | 70 | 66.6 | 0.448 | 1.04 | 2.42 | |
| | 40 | PV | D | 15 | 7 | 80 | 86.1 | 0.369 | 0.98 | 2.18 | |
| | 40 | PV | D | 15 | 7 | 90 | 73.2 | 0.460 | 1.16 | 2.18 | 15.0 |

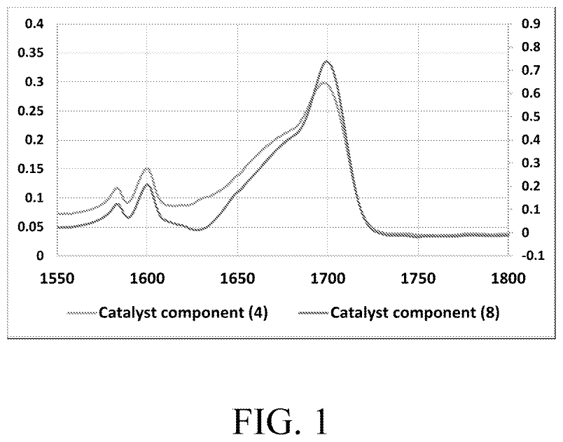

Example 71. Donor Coordination in Treated and Non-treated Catalysts. The effect of the incorporation of an ACA on donor coordination was studied by comparing the FTIR spectrums of catalyst components with and without an ACA. FIG. 1 illustrates the effect of D-donor on the coordination of a CDB-2 donor. A broad peak in the region of 1700 cm−1 is associated with C═O groups from the CDB-2 donor and ethyl benzoate. To understand the specific differences in coordination of the internal donor, the peak was deconvoluted into several peaks of different assigned complexes on the MgCl₂ surface: Donor/Q4-and Donor/Q5-MgCl2 (Table 20).

The ratio of CDB-2 Q5/Q4-MgCl2 complexes and the maximum frequency for C═O groups in the FTIR spectrum were analyzed for their effects on catalyst lifetime (distribution of catalyst activity between 1st and 2nd hour of polymerization process).

It was found that increasing the Q5/Q4 ratio (increasing concentration of weak complexes) resulted in increased catalyst activity in the second hour of polymerization.

TABLE 20

| | | CDB-2/ | CDB-2/ | EB/ | EB/ | | First |
|---|---|---|---|---|---|---|---|
| | | MgCl₂, | MgCl₂, | MgCl₂, | MgCl₂, | | hour/second |
| Catalyst | | cm⁻¹ | cm⁻¹ | cm⁻¹ | cm⁻¹ | CDB-2 | hour CE, kg/g/h, |
| component | Condition | (Q5) | (Q4) | (Q5) | (Q4) | Q5/Q4 | % |
| 4 | Non-treated | 1705.9 | 1694.8 | 1680.2 | 1666.2 | 0.75 | 58.4/41.6 |
| | | (0.75) | (1.00) | (0.56) | (0.51) | | |
| 8 | Cat. comp. 4 + | 1703.9 | 1694.1 | 1679.8 | 1664.7 | 1.43 | 54.7/45.3 |
| | 0.1 mol D/mol Ti | (1.00) | (0.70) | (0.57) | (0.43) | | |
| 9 | Cat. comp. 4 + | 1703.9 | 1692.1 | 1679.1 | 1663.0 | 3.50 | 51.3/48/7 |
| | 0.5 mol D/mol Ti | (1.00) | (0.29) | (0.48) | (0.39) | | |

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

1. An isolated solid catalyst component for olefin polymerization, the component comprising a reaction product of:
a halide-containing magnesium compound;
a titanium halide compound;
a supportive donor comprising a benzoate;
an internal electron donor; and
an activity control agent (ACA) comprising at least one of:
a first organosilicon compound containing Si—O groups being present in the catalyst component in an amount from about 0.1 to about 5% by weight;
an organic ester of a C₄ to C₃₀ aliphatic acid or a poly(alkene glycol) ester of a C₄ to C₃₀ aliphatic acid in amount from about 0.1% to about 15% by weight; and
an organo-aluminum compound containing an alkyl group,
wherein at least a part of the ACA is chemically bonded to the halide-containing magnesium compound.

2. The solid catalyst component of claim 1, wherein the supportive electron donor is present in the catalyst component in an amount from about 0.5% to about 7% by weight.

3. The solid catalyst component of claim 1, wherein the internal electron donor is present in the catalyst component in an amount from about 3% to about 25% by weight.

4. The solid catalyst component of claim 1, wherein the internal electron donor comprises a diester, a diether, a succinate, or any combination thereof.

5. The solid catalyst component of claim 1, wherein the halide-containing magnesium compound comprises magnesium chloride.

6. The solid catalyst component of claim 1, wherein the first organosilicon compound is a silane, siloxane or polysiloxane having the following chemical structure:
RₙSi(OR′)₄₋ₙ
wherein:
each R is H, alkyl, or aryl;
each R′ is H, alkyl, aryl, or a SiR_{n′}(OR′)₃₋ₙ; and
n is 0, 1, 2, or 3.

7. The solid catalyst component of claim 1, wherein the internal electron donor is represented by the following formula: 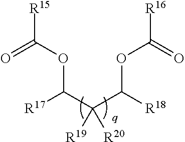
wherein:
each of R¹⁵ through R²⁰ are independently H, F, Cl, Br, I, alkyl, cycloalkyl, cycloalkylalkyl, aryl, aralkyl, heterocyclyl, heterocyclylalkyl, heteroaryl, or heteroarylalkyl; and
q is an integer from 0 to 12.

8. The solid catalyst component of claim 1, wherein the internal electron donor is represented by one of the following formulas: 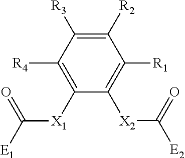
where R₁-R₄, are the same or different and each R₁-R₄ is selected from the group consisting of hydrogen, a substituted hydrocarboyl group having 1 to 20 carbon atoms, an unsubstituted hydrocarobyl having 1 to 20 carbon atoms, a substituted or unsubstituted aryl group having 6 to 20 carbons, an alkoxy group having 1 to 20 carbon atoms, a heteroatom and combinations thereof and at least one of R₁-R₄ is not hydrogen; and
E₁ and E₂ are the same or different and each E₁ and E₂ is selected from the group consisting of a substituted hydrocarboyl group having 1 to 20 carbon atoms, an unsubstituted hydrocarobyl having 1 to 20 carbon atoms, a substituted or unsubstituted aryl group having 6 to 20 carbons, an alkoxy group having 1 to 20 carbon atoms, a heteroatom and combinations thereof
wherein X₁ and X₂ are each O, S, an alkyl group, or NR₅ and wherein R₅ is a hydrocarbyl group having 1 to 20 carbon atoms or is hydrogen; 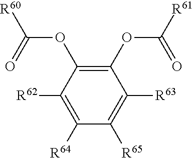
wherein:
each of R⁶⁰ through R⁶⁵ are independently H, F, Cl, Br, I, alkyl, cycloalkyl, cycloalkylalkyl, aryl, aralkyl, heterocyclyl, heterocyclylalkyl, heteroaryl, or heteroarylalkyl; or 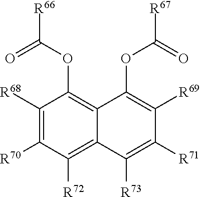
wherein each of R⁶⁶ through R⁷³ are independently H, F, Cl, Br, I, alkyl, cycloalkyl, cycloalkylalkyl, aryl, aralkyl, heterocyclyl, heterocyclylalkyl, heteroaryl, or heteroarylalkyl groups.

9. The solid catalyst component of claim 1, wherein the supportive electron donor has the following formula: 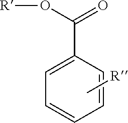
wherein R′ comprises an alkyl group, a cyclic group, an aryl group having from 1 to 20 carbon atoms, a heteroatom or a combination thereof, and wherein R″ comprises one or more substituted groups, each substituted group can comprise independently hydrogen, an alkyl group, a cyclic group, an aryl group having from 1 to 20 carbon atoms, a heteroatom, or a combination thereof.

10. The solid catalyst component of claim 1, further comprising a second organosilicon compound different from the first organosilicon compound.

11. The solid catalyst component of claim 10, wherein the second organosilicon compound comprises tetraethylorthosilicate and/or polydimethyl siloxane.

12. The solid catalyst component of claim 1, wherein the first organosilicon compound comprises dicyclopentyldimethoxysilane, cyclohexylmethyldimethoxysilane, n-propyltrimethoxysilane, trimethoxysilane, or any combination thereof.

13. The solid catalyst component of claim 1, wherein the ACA comprises an organosilicon compound and no organo-aluminum component is contained in the catalyst component.

14-16. (Canceled)

17. The solid catalyst component of claim 1, wherein the ACA comprises an organic ester selected from the group consisting of isopropyl myristate, di-n-butyl sebacate, (poly) (alkylene glycols), mono-or di-myristates, pentyl valerate, and combinations thereof.

18. The solid catalyst component of claim 1, wherein the ACA comprises a combination of a) dicyclopentyldimethoxysilane, cyclohexylmethyldimethoxysilane, n-propyltrimethoxysilane, and/or trimethoxysilane and b) an organic ester selected from the group consisting of isopropyl myristate, di-n-butyl sebacate, (poly) (alkylene glycols), mono-or di-myristates, pentyl valerate, and combinations thereof.

19-21. (canceled)

22. A process for producing a solid catalyst component, the process comprising:
forming a catalyst precursor component by reacting a magnesium alkoxide Mg(OR)ₙX₂₋ₙ or magnesium alcoholate MgX₂mR′OH with Ti(OR″)_{g}X_{4-g} wherein X is Br, Cl, or I; n is 1, 2; m is 0.5-10; g is 0, 1, 2, 3, or 4; and R, R′, R″ are independently C1-C10 alkyl, the catalyst precursor containing a supportive electron donor and an internal electron donor;
reacting the catalyst precursor component with at least one of:
a first organosilicon compound having the following formula: R₂nSi(OR₃)₄₋ₙ, wherein R₂ is H, alkyl, or aryl; each R₃ is alkyl, or aryl; n is 0, 1, 2 or 3 in hydrocarbon solvent;
an organic ester from a C₄ to C₃₀ aliphatic acid ester or a poly(alkene glycol) ester of a C₄ to C₃₀ aliphatic acid; or an alkyl aluminum compound; and
isolating the solid catalyst component.

23. The process of claim 22, further comprising isolating and or/drying the catalyst precursor compound before the reacting the catalyst precursor step.

24. The process of claim 22, wherein the supportive electron donor is present in the catalyst component in an amount from about 0.5% to about 7% by weight.

25-30. (canceled)

31. The process of claim 22, further comprising incorporating a second organosilicon compound different from the first organosilicon compound into the catalyst precursor component.

32-34. (canceled)

35. A process for producing an olefin polymer, the process comprising polymerizing an olefin in the presence of an isolated solid catalyst component, the solid catalyst component comprising a reaction product of:
a halide-containing magnesium compound;
a titanium halide compound;
at least one internal electron donor; and
an activity control agent (ACA) comprising at least one of:
a first organosilicon compound containing Si—O groups being present in the catalyst component in an amount from about 0.1 to about 5% by weight;
an organic ester of a C₄ to C₃₀ aliphatic acid or a poly(alkene glycol) ester of a C₄ to C₃₀ aliphatic acid in amount from about 0.1% to about 15% by weight; and
an organo-aluminum compound containing an alkyl group, wherein at least a part of the ACA is chemically bonded to the halide-containing magnesium compound, and wherein the solid catalyst component is not prepared in a polymerization reactor.

36-51. (canceled)
